(19) United States
(12) Patent Application Publication
(10) Pub. No.: US 2009/0085859 A1
(43) Pub. Date: Apr. 2, 2009

(54) DISPLAY APPARATUS AND CONTROL METHOD THEREOF

(75) Inventor: Ki-hong Song, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/110,492

(22) Filed: Apr. 28, 2008

(30) Foreign Application Priority Data
Sep. 28, 2007 (KR) 10-2007-0098332

(51) Int. Cl. G02F 1/13357; G09G 3/36

(52) U.S. Cl. 345/102; 349/61

(57) ABSTRACT

A display apparatus includes a display panel which includes a data pixel which is formed to a display area in which an image is displayed, and a dummy pixel which is formed to a non display area in which the image is not displayed, a light source unit which supplies a light to the data pixel and the dummy pixel, a light source driving unit which supplies a driving power to the light source unit, a light sensing unit which senses the light emitted from the dummy pixel, and a light source control unit which controls the light source driving unit so that at least one of brightness and a color coordinate of sensed light has a predetermined reference value.

This application claims priority to Korean Patent Application No. 10-2007-0098332, filed on Sep. 28, 2007, and all the benefits accruing therefrom under 35 U.S.C. §119, the contents of which in its entirety are herein incorporated by reference.

### BACKGROUND OF THE INVENTION

1. Field of the Invention

The present invention relates to a display apparatus and a control method thereof, and more particularly, to a display apparatus including a backlight unit with light sensing and a control method of the display apparatus.

2. Description of the Related Art

Recently, a liquid crystal display (“LCD”) apparatus has been widely used among display apparatuses. The LCD apparatus includes a liquid crystal panel provided with a first substrate formed with a thin film transistor (“TFT”), and a second substrate formed with a color filter layer of red, green and blue.

In general, the LCD apparatus supplies a white light emitted from a light source to the red, green and blue color filter layer, and synthesizes red, green and blue light transmitting the red, green and blue color filter layer, thereby displaying a desired color.

A property of a light emitted from the light source, for example, brightness, a color coordinate, or the like has a close relation to an environment under which a user views an image. Thus, a mechanism sensing the light, and feeding back a condition of the sensed light for adjusting these is important in controlling the light source.

Recently, for sensing the light emitted from the light source, a lighting window has been used, a separate calibration device has been used, or an additional pixel for sensing the light has been provided. When using the lighting window, a physical transformation of a backlight unit is necessary, and when using the calibration device, it is necessary that the user inconveniently performs correction by a predetermined period. Also, when providing the additional pixel, an additional driving unit for generating a test signal applied to the pixel and applying this thereto is necessary.

### BRIEF SUMMARY OF THE INVENTION

Accordingly, exemplary embodiments of the present invention provide a display apparatus and a control method thereof easily sensing the brightness of a light emitted from a backlight unit with a separate configuration.

Other exemplary embodiments of the present invention provide a display apparatus and a control method thereof easily controlling the brightness or a color temperature of a light.

The foregoing and/or other exemplary embodiments of the present invention can be achieved by providing a display apparatus including a display panel which includes a data pixel which is formed to a display area, and a dummy pixel which is formed to a non display area, a light source unit which supplies a light to the data pixel and the dummy pixel, a light source driving unit which supplies a driving power to the light source unit, a light sensing unit which senses the light emitted from the dummy pixel, and a light source control unit which controls the light source driving unit so that at least one of brightness and a color coordinate of sensed light has a predetermined reference value.

The display panel may further include a light blocking pattern which is formed to portions of the non display area in which the dummy pixel is not formed.

The display panel may include a first substrate which has the data pixel and the dummy pixel, and a second substrate which has a common electrode which applies a common voltage. A black matrix may be formed in the display area, and the light blocking pattern and the black matrix may be formed in a same layer of the display panel.

The display apparatus may further include a chassis member, which includes an opening corresponding to the display area, and which supports the display panel and the light source unit.

The light sensing unit may be positioned between the dummy pixel and the chassis member.

The chassis member may include a portion framing the display area and overlapping the non-display area. The light sensing unit may be positioned between the display panel and the portion of the chassis member framing the display area. The dummy pixel may be overlapped by the portion of the chassis member framing the display area.

The data pixel may include a gate line to which a gate signal is applied, a data line to which a data signal is applied, and which crosses the gate line, and a data thin film transistor (“TFT”) connected with the gate line and the data line, and the dummy pixel may include a dummy TFT connected with the gate line and the data line.

The light source control unit may control the light source driving unit so that the driving power supplied to the light source unit increases when the brightness of the sensed light is smaller than a predetermined first reference value. The light source control unit may control the light source driving unit so that the driving power supplied to the light source unit decreases when the brightness of the sensed light is greater than the first reference value.

The light sensing unit may sense color information of the light emitted from the dummy pixel, and the light source control unit may detect the color information from the sensed light, and may control the light source driving unit based on detected color information so that the color coordinate of the light has a predetermined second reference value.

The dummy pixel may receive a video signal corresponding to white.

The foregoing and/or other exemplary embodiments of the present invention can be achieved by providing a display apparatus including a display panel which includes a data pixel which is formed to a display area, and a dummy pixel which is formed to a non display area, a light source unit which supplies a light to the data pixel and the dummy pixel, and a light sensing unit which senses the light emitted from the dummy pixel, wherein a data TFT of the data pixel and a dummy TFT of the dummy pixel are connected to a same data line and a same gate line.

The display apparatus may further include a chassis member which includes a portion framing the display area and overlapping the non-display area, and supports the display panel and the light source unit, wherein the light sensing unit is positioned between the display panel and the portion of the chassis member framing the display area.

The foregoing and/or other exemplary embodiments of the present invention can also be achieved by providing a control method of a display apparatus which includes a light source unit, the control method of the display apparatus including providing a display panel with a data pixel to a display area, and a dummy pixel to a non display area, sensing a light which is emitted from the light source unit via the dummy pixel, and controlling a driving power which is supplied to the light source unit so that at least one of brightness and a color coordinate of sensed light has a predetermined reference value.

Controlling the driving power may include increasing the driving power when the brightness of the sensed light is smaller than a predetermined first reference value.

Controlling the driving power may include detecting color information from the sensed light, and supplying the driving power to the light source unit based on detected color information so that the color coordinate of the light has a predetermined second reference value.

Providing the display panel with a data pixel and a dummy pixel may include connecting a data TFT of the data pixel and a dummy TFT of the dummy pixel to a same gate line and a same data line.

### BRIEF DESCRIPTION OF THE DRAWINGS

These and/or other exemplary embodiments of the present invention will become apparent and more readily appreciated from the following description of the exemplary embodiments, taken in conjunction with the accompanying drawings, in which:

FIG. 1 is a control block diagram of an exemplary display apparatus according to a first exemplary embodiment of the present invention;

FIG. 2 is a schematic view of an exemplary display panel according to the first exemplary embodiment of the present invention;

FIG. 3 is an enlarged view of portion A in FIG. 2;

FIG. 4 is a sectional view of the exemplary display apparatus according to the first exemplary embodiment of the present invention;

FIG. 5 is a control flowchart illustrating an exemplary control method of an exemplary display apparatus according to a first exemplary embodiment of the present invention; and

FIG. 6 is a control flowchart illustrating an exemplary control method of an exemplary display apparatus according to a second exemplary embodiment of the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. The exemplary embodiments are described below so as to explain the present invention by referring to the figures.

This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

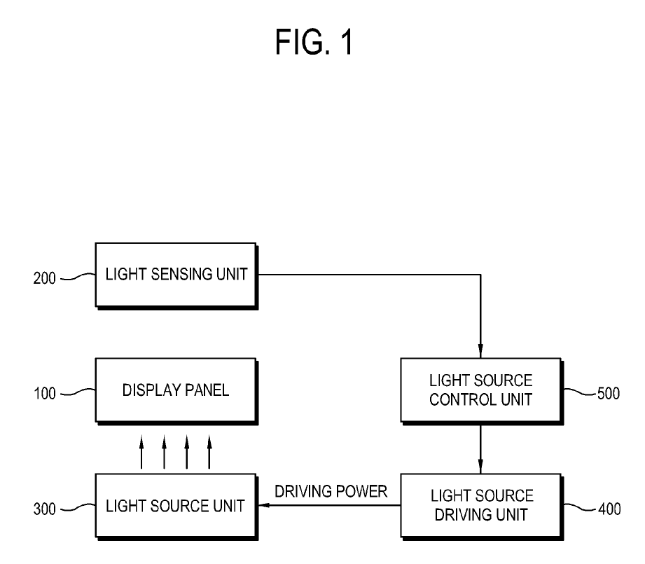

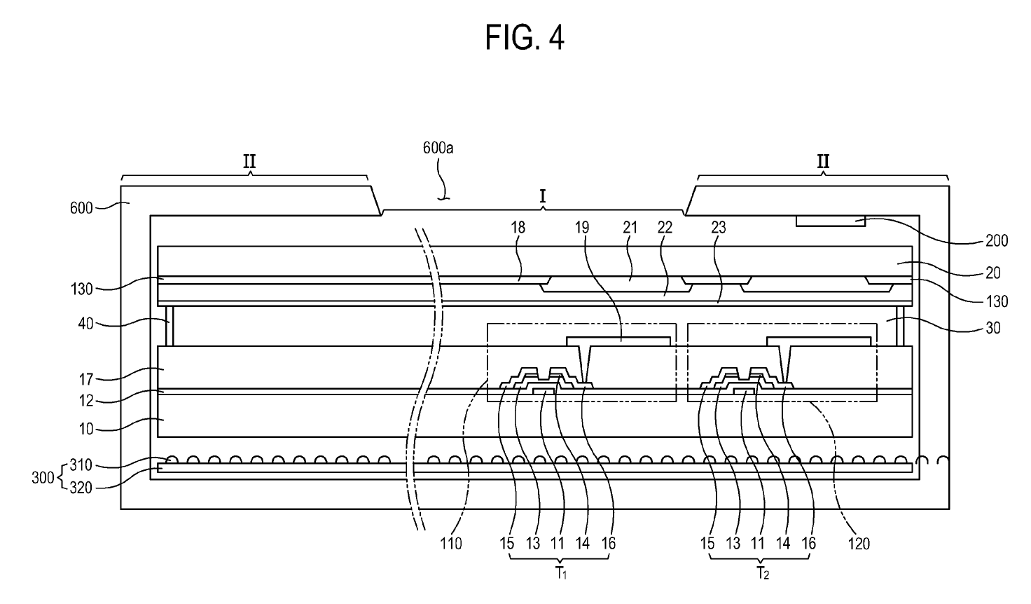

FIG. 1 is a control block diagram of an exemplary display apparatus according to a first exemplary embodiment of the present invention, and FIG. 4 is a sectional view of the exemplary display apparatus according to the present exemplary embodiment. As shown in therein, the display apparatus includes a display panel 100, a light sensing unit 200, a light source unit 300, a light source driving unit 400 and a light source control unit 500. The display apparatus is a liquid crystal display (“LCD”) apparatus including the light source unit 300 supplying a light to the display panel 100. The display panel 100 and the light source unit 300 are supported and accommodated to a chassis member 600.

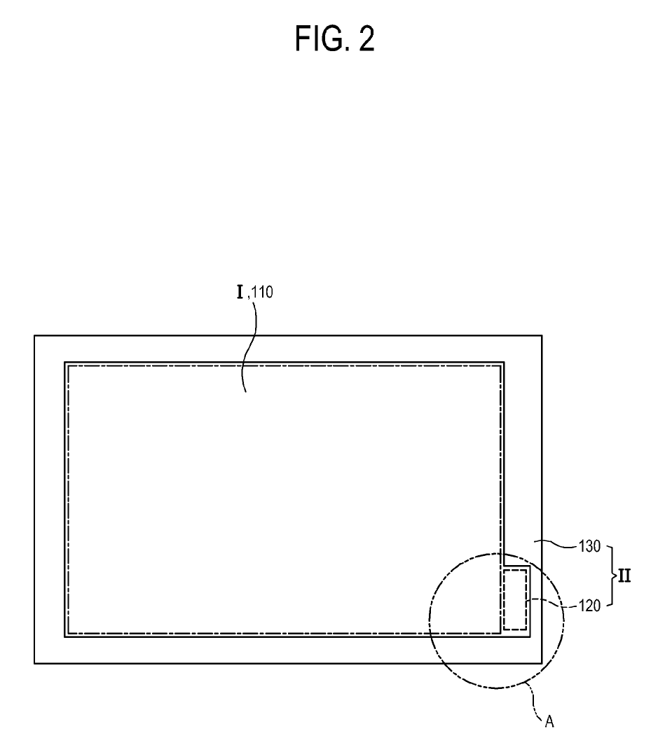

FIG. 2 is a schematic view of the display panel 100. As shown therein, the display panel 100 may be divided into a display area I in which an image is displayed, and a non display area II in which the image is not displayed. In the illustrated exemplary embodiment, the display panel 100 has a rectangular shape, and the display area I has a rectangular shape. Alternatively, the display panel 100 may have an alternate polygonal shape including a square shape, or a circular shape instead of the rectangular shape, and this case, the shape of the display area I may correspond to the shape of the display panel 100. The non display area II surrounds an outer periphery of the display area I, and is provided to a circumference around the display panel 100. A data pixel 110 to which a video signal is applied is formed in a lattice shape, such as in a matrix, in the display area I, and a dummy pixel 120 and a light blocking pattern 130 are formed in the non display area II.

In the conventional display apparatus, the light blocking pattern is uniformly formed to the circumference around the display panel. However, in the present exemplary embodiment, the dummy pixel 120 is formed to a part of the non display area II in which the light blocking pattern is formed in the conventional display apparatus. Since the light source unit 300 is provided to a rear side of the display panel 100 as shown in FIG. 4, a light emitted from the light source unit 300 transmits through to the dummy pixel 120 in addition to the data pixel 110.

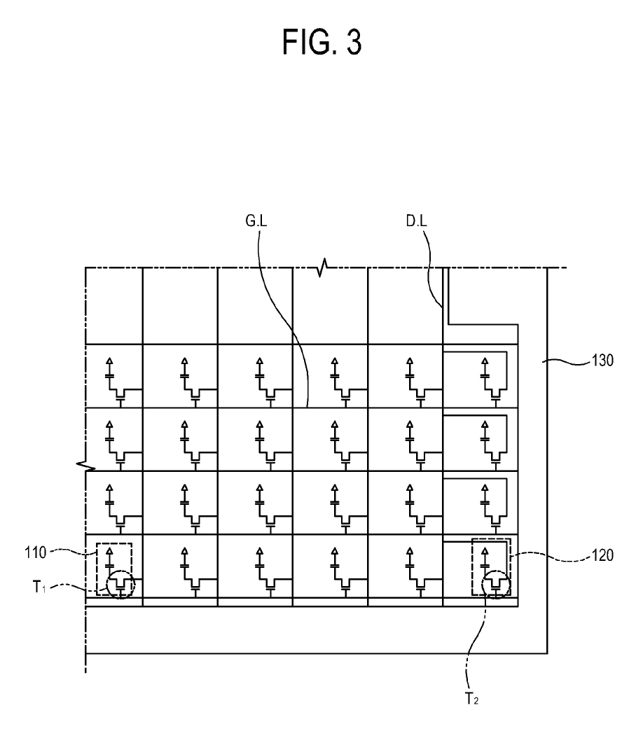

FIG. 3 is an enlarged view of portion A in FIG. 2. As shown therein, the display panel 100 includes a gate line G.L extending in a long side of the display panel 100, such as in a first direction, and a data line D.L crossing the gate line G.L and extending in a second direction substantially perpendicular to the first direction, and thin film transistors (“TFTs”) T1 and T2 are formed for driving pixels and are formed to the gate line G.L and the data line D.L. If a gate on signal is applied to the TFTs T1 and T2 through the gate line G.L, a data signal corresponding to the video signal is inputted through the data line D.L. The gate line G.L may include a plurality of gate lines extending in the first direction, the data line D.L may include a plurality of data lines extending in the second direction, and a plurality of TFTs T1 and T2 may be respectively connected to the gate lines and data lines. Each pixel is provided with one of TFT T1 and T2, and a pixel electrode 19 in FIG. 4 connecting to the TFT T1 and T2. The data pixel 110 is formed in a matrix type in the display area I, and the dummy pixel 120 is formed in the non display area II vicinal to the data pixel 110 formed to the circumference around the display area I. The data pixel 110 may thus includes a plurality of data pixels arranged in the display area I, and the dummy pixel 120 may include a plurality of dummy pixels arranged in the non display area II.

The data pixel 110 includes a data TFT T1, and the dummy pixel 120 includes a dummy TFT T2. A gate electrode of the dummy TFT T2 is connected to the gate line G.L to which the data pixel 110 is connected. A data electrode of the dummy TFT T2 is connected to the data line D.L to which the data pixel 110 is connected. That is, the dummy pixel 120 is driven by using the existing gate line G.L and the data line D.L without forming separate gate line and data line connected with the dummy pixel 120. Also, the dummy pixel 120 is applied with the same data signal as the data signal applied to the data pixel 110 adjacently arranged to the dummy pixel 120. That is, it is unnecessary to provide an additional data line for applying a data signal to the dummy pixel 120.

The data pixel 110 and the dummy pixel 120 will be described more in detail by referring to FIG. 4. The display panel 100 includes a first substrate formed with the data pixel 110 and the dummy pixel 120, and a second substrate facing the first substrate.

In the first substrate, a gate electrode 11 is formed on a first substrate member 10. The gate electrode 11 is connected to the gate line G.L in FIG. 3, and may be formed as a single metal layer or a plurality of metal layers. A storage electrode (not shown) forming a storage capacity may be further provided within the same layer as the gate electrode 11.

A gate insulating layer 12, which may be made of silicon nitride SiNx, covers the gate electrode 11 on the first substrate member 10. The gate insulating layer 12 may further cover the storage electrode and exposed portions of the first substrate member 10.

A semiconductor layer 13 is formed of a semiconductor such as an amorphous silicon (“a-Si”), etc. on the gate insulating layer 12 overlapping the gate electrode 11, and an ohmic contact layer 14 may be formed of material such as silicide and a hydrogenated n+a-Si doped with an n-type impurity. over the semiconductor layer 13. The ohmic contact layer 14 may be divided into two parts.

A data wiring is formed on the ohmic contact layer 14 and the gate insulating layer 12. The data wiring 15 and 16 may be provided as a single layer or a plurality of metal layers. The data wiring includes the data line D.L crossing the gate line G.L, a source electrode 15 branched from the data line D.L to extend to an upper part of the ohmic contact layer 14, and a drain electrode 16 separated from the source electrode 15 and formed on a side of the ohmic contact layer 14. The data TFT T1 and the dummy TFT T2 each including the gate electrode 11, the source electrode 15, the drain electrode 16, the semiconductor layer 13, etc. are formed in the first substrate.

A passivation layer 17 is formed on the data wiring, and the semiconductor layer 13 not covered by the data wiring. The passivation layer 17 may be further formed on exposed portions of the gate insulating layer 12. The passivation layer 17 may include silicon nitride, a-Si:C:O or a-Si:O:F deposited by means of a plasma enhanced chemical vapor deposition (“PEVCD”) method, an acryl series organic insulating material formed by means of a coating method, etc. A contact hole exposing the drain electrode 16 is formed in the passivation layer 17.

The pixel electrode 19 is formed on the passivation layer 17. The pixel electrode 19 may be formed of a transparent conductive material such as indium tin oxide (“ITO”), indium zinc oxide (“IZO”), etc. The pixel electrode 19 may include an incised pattern or a protrusion dividing the data pixel 110 and the dummy pixel 120 into a plurality of domains. An alignment layer (not shown) for aligning a liquid crystal layer 30 may be formed on the pixel electrode 19.

Next, the second substrate will be described.

A black matrix 18 may be formed on a second substrate member 20 corresponding to the data TFT T1 and the dummy transistor T2 to block a light. The black matrix 18 typically divides among red, green and blue filters, and prevents the light from being directly emitted to the semiconductor layer 13 positioned to the first substrate. The black matrix 18 may be formed of a photosensitive organic material added with a black pigment. For the black pigment, carbon black, titanium oxide, etc. may be used.

As shown in FIG. 4, the light blocking pattern 130 formed to the circumference of the display panel 100 formed with the dummy pixel 120, and the opposite side to the display panel 100 formed with the dummy pixel 120 is formed of the same material as the black matrix 18 within the same layer as the black matrix 18. As shown therein, the chassis member 600 covers a part formed with the light blocking pattern 130, and the dummy pixel 120. That is, the non-display area II is overlapped by the chassis member 600, and the upper portion of the chassis member 600 forms a window for the display area I.

In the present exemplary embodiment, the black matrix 18 is formed to the second substrate member 20. Alternatively, the black matrix 18 may be formed to the first substrate member 10 formed with the data TFT T1 and the dummy TFT T2. Here, the light blocking pattern 130 may also be formed to the first substrate in the same layer as the black matrix 18, or separately formed to the second substrate.

The color filter 21 is formed to between the black matrix 18 corresponding to the pixel electrode 19 of the first substrate. The black matrix 18 bounds the color filter 21. That is, in a plan view, the black matrix 18 surrounds the color filter 21 within each pixel area. The color filter 21 includes three sub layers of red, green and blue. The color filter 21 supplies color to the light emitted from the light source unit 300 and transmitting the liquid crystal layer 30. The color filter 21 may be formed of a photoresist organic material.

An over coat layer 22 is formed on the color filter 21. The over coat layer 22 is formed of an organic material, and provides a planar surface. The over coat layer 22 may further cover exposed portions of the second substrate member 20. Alternatively, the over coat layer 22 may be unnecessary.

A common electrode 23 is formed on the over coat layer 22. The common electrode 23 is formed of a transparent conductive material such as ITO, IZO, etc. A common voltage applied to the common electrode 23 forms an electric field to the liquid crystal layer 30 together with a data voltage applied to the pixel electrode 19 of the first substrate. An alignment layer (not shown) is formed on the common electrode 23.

A sealant 40 is disposed on either the first substrate or the second substrate to assemble the first substrate and the second substrate together and enclose the liquid crystal layer 30 there between.

The light source unit 300 is provided to the rear side of the display panel 100, and includes a point light source 310 disposed to be arranged over a substantial portion of the rear side of the display panel 100, and a point light source circuit substrate 320 on which the point light source 310 is mounted. The point light source 310 forms a point light source unit emitting red, green and blue lights, and the lights emitted from the point light source unit are mixed to become a white light to enter the display panel 100. The point light source 310 includes a chip (not shown) emitting a light, a lead (not shown) connecting the chip and the point light source circuit substrate 320, a plastic mold (not shown) accommodating the lead and surrounding the chip, and a silicon resin part and a bulb positioned on the chip. If the brightness of the light from the light source unit 300 is not appropriate, and especially if the brightness is low, an image is darkly displayed on the display panel 100. Therefore, a user cannot view the image having a good quality. Also, if a color coordinate of the light emitted from the point light source 310 deviates from a permissible reference range, the image appears reddish or blueish. Since a property of the light emitted from the light source unit 300 has a direct relation to displaying of the image, it is important to sense the property of the light. In an alternative exemplary embodiment, the light source unit 300 may include a surface light source or a line light source such as a lamp instead of the point light source 310.

The point light source 310 is formed to a first surface of the point light source circuit substrate 320 facing the display panel 100, and a circuit such as the light source driving unit 400 and the light source control unit 500 is mounted on a second surface thereof facing the bottom portion of the chassis member 600. Since a significant amount of heat is generated in the point light source 310, the point light source circuit substrate 320 may be mainly formed of a material having a good heat transmission, such as aluminum (Al).

The light sensing unit 200 is provided between an upper part of the display panel 100 corresponding to the dummy pixel 120 and the chassis member 600, and senses the light emitted from the light source unit 300 via the dummy pixel 120. In an exemplary embodiment, the light sensing unit 200 may be provided between the second substrate and the upper portion of the chassis member 600. The light sensing unit 200 is provided as a photo diode, and is electrically connected with the light source control unit 500. The light sensed by the light sensing unit 200 is supplied to the light source controlling unit 500. The dummy pixel 120 according to the present exemplary embodiment is a pixel used to sense the light emitted from the light source unit 300, and senses the light for adjusting the brightness, the color coordinate or the like of the light emitted from the light source unit 300. That is, the light sensing unit 200 senses the light having the same condition as the light transmitting the display panel 100. In the conventional display apparatus, a lighting window is provided to the point light source circuit substrate, etc. to sense an indirect light transmitting the lighting window, or a separate pixel is formed and a test signal is applied thereto to sense the light. When forming the light window to sense the light, since the brightness of an actual light and the brightness of the light transmitting the lighting window may have differences by several tens times, it is difficult to obtain a correct brightness, and a separate correcting process for correcting such a difference is necessary. Also, when forming the separate pixel for sensing the light and applying the test signal, a logic for generating the test signal is necessary, and resolution of the display panel 100 may be changed due to addition of the pixel.

In the present exemplary embodiment, the dummy pixel 120 for sensing the light is formed in the non display area II in which the image is inherently not displayed, thereby having no effect on resolution of the display panel 100. Also, since the gate signal and the data signal are applied by using the same gate line G.L and the data line D.L as the data pixel 110, the light can be sensed under the same condition as the display area I in which the image is actually displayed. Accordingly, the logic for generating the test signal is unnecessary, and a physical change such as the light window is unnecessary. In brief, the display panel 100 according to the present exemplary embodiment includes the dummy pixel 120 for sensing the light in a part of the non display area II in which the light blocking pattern 130 was formed, and drives the dummy pixel 120 by using the existing gate line and the data line. The light blocking pattern 130 is indented in an area of the dummy pixel 120 to allow light to transmit to the dummy pixel 120.

The chassis member 600 supports and accommodates the display panel 100 and the light source unit 300 supplying the light the display panel 100 to be distanced from each other. The chassis member 600 covers the non display area II formed with the dummy pixel 120 and the light blocking pattern 130, and includes an opening 600a corresponding to the display area I. The user views the image through the opening 600a.

The light source driving unit 400 supplies a driving power to the light source unit 300, and the brightness, the color temperature or the like are adjusted depending on the driving power supplied from the light source driving unit 400. The light source driving unit 400 may include a pulse width modulation (“PWM”) generating unit (not shown) controlling the point light source 310 by a PWM method, a switching unit regulating the driving power depending on a control of the PWM generating unit, etc. The light source driving unit 400 may simultaneously supply the driving power to all point light sources 310 emitting lights having different colors, or may supply the driving power in sequence by each point light source 310 emitting a light having a different color.

The light source control unit 500 adjusts the brightness of the light depending on the light sensed by the light sensing unit 200. The light source control unit 500 controls the light source driving unit 400 so that the light sensed by the light sensing unit 200 has a first reference value which is a reference brightness value. Brightness information of the light outputted from the light sensing unit 200 is an electric signal such as a voltage, etc. The light source control unit 500 may include an analogue to digital converter converting the voltage to a digital signal.

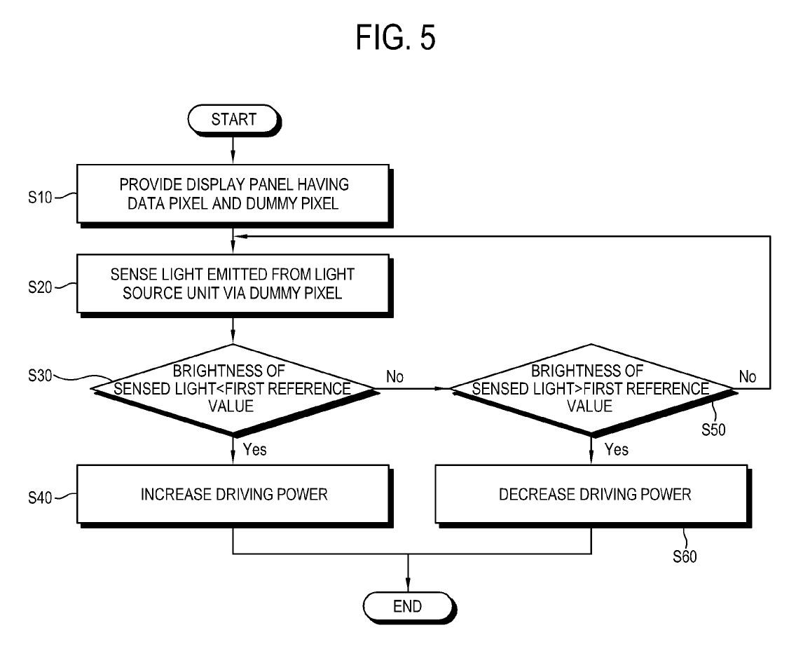

FIG. 5 is a control flowchart illustrating an exemplary control method of an exemplary display apparatus according to a first exemplary embodiment. Hereinafter, a brightness control method of a light will be described. At first, the display panel 100 including a data pixel 110 and the dummy pixel 120 is provided (S10). A light emitted from the light source unit 300 provided to a rear side of the display panel 100 transmits through the data pixel 110 to display an image.

The light from the light source unit 300 also transmits through the dummy pixel 120. The light sensing unit 200 senses the light emitted from the light source unit 300 via the dummy pixel 120 (S20).

The light source control unit 500 determines whether brightness of the sensed light is smaller than a predetermined first reference value or not (S30). When the brightness of the light is smaller than the first reference value, then it is determined that the brightness of the light is so low that the image looks dark. Therefore, the light source control unit 500 controls a light source driving unit 400 to increase a driving power supplied to the light source unit 300 (S40). The light source control unit 500 adjusts a PWM control signal outputted to a PWM generating unit of the light source driving unit 400 based on a digital signal corresponding to the brightness of the sensed light.

On the other hand, if the brightness of the sensed light exceeds the first reference value (S50), then the light source control unit 500 controls the light source driving unit 400 to decrease the driving power supplied to the light source unit 300 (S60). If the brightness of the sensed light is the same as the first reference value, then the size of the driving power is not adjusted and the control method continues to sense light emitted from the light source unit 300 via the dummy pixel 120. A brightness information of the sensed light is fed back to the light source control unit 500 in real time for adjusting the driving power outputted from the light source driving unit 400. Since the sensed light has the same brightness as the light of a display area I viewed by a user, the light source control unit 500 can more correctly adjust the brightness of the light.

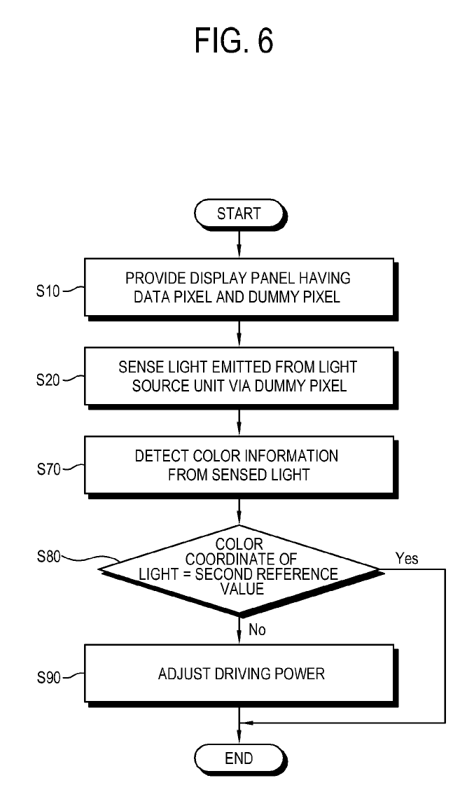

FIG. 6 is a control flowchart illustrating an exemplary control method of an exemplary display apparatus according to a second exemplary embodiment of the present invention. A light source control unit 500 according to the present exemplary embodiment adjusts a color coordinate of a light by using a sensed light detected by light sensing unit 200. A white balance of an image is adjusted by adjusting the color coordinate of the light. For adjusting the white balance, a display panel 100 may apply a video signal corresponding to white to a data pixel 110 or a dummy pixel 120. Light sensing unit 200 senses a white light transmitting through the display panel 100, and the light source control unit 500 extracts color information of each light from the white light to adjust the color coordinate.

At first, operations S10 and S20 may be the same as the control method shown in FIG. 5.

The light source control unit 500 detects the color information corresponding to red, green and blue from the sensed light (S70). For convenience of description, the red, green, and blue colors may be termed primary colors. The light source control unit 500 detects ratio with respect to the three primary colors of light, intensity, etc. from the sensed white light.

Then, the light source control unit 500 calculates the color coordinate of the light by means of the detected color information, and determines whether the calculated color coordinate accords to a predetermined second reference value or not (S80). The light source control unit 500 may include a lookup table about the color coordinate corresponding to the color information. The second reference value is determined as the color coordinate in which a user can view the most appropriate image, but may be changed depending on preference of the user.

If the color coordinate of the light is determined to be different from the second reference value, the light source driving unit 400 individually adjusts driving voltages supplied to point light sources 310 emitting different colors so that the color coordinate of the light becomes the second reference value (S90). If the color coordinate of the light is determined to be the same as the second reference value, then the driving voltages supplied to the point light sources 310 need not be adjusted. In an alternative exemplary embodiment, if the color coordinate of the light is determined to be substantially the same as the second reference value, then the driving voltages supplied to the point light sources 310 need not be adjusted.

The method of adjusting the brightness or the color coordinate of the light is not limited to the method as described above, and various alternative methods may be applied thereto. In the present invention, the dummy pixel 120 is formed to the non display area II of the display panel 100, and the light having the same environment as the light viewed by the user is sensed. The sensed light is used in adjusting the brightness or the color coordinate.

As described above, the present invention provides a display apparatus and a control method thereof easily sensing the brightness of a light emitted from a backlight unit with a separate configuration.

Also, the present invention provides a display apparatus and a control method thereof easily controlling the brightness or a color temperature of a light.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus, comprising:
a display panel which comprises a data pixel which is formed to a display area, and a dummy pixel which is formed to a non display area;
a light source unit which supplies a light to the data pixel and the dummy pixel;
a light source driving unit which supplies a driving power to the light source unit;
a light sensing unit which senses the light emitted from the dummy pixel; and
a light source control unit which controls the light source driving unit so that at least one of brightness and a color coordinate of sensed light has a predetermined reference value.

2. The display apparatus according to claim 1, wherein the display panel further comprises a light blocking pattern which is formed to portions of the non display area in which the dummy pixel is not formed.

3. The display apparatus according to claim 2, wherein the display panel comprises
a first substrate which has the data pixel and the dummy pixel, and
a second substrate which has a common electrode which applies a common voltage.

4. The display apparatus according to claim 2, further comprising a black matrix formed in the display area, wherein the light blocking pattern and the black matrix are formed in a same layer of the display panel.

5. The display apparatus according to claim 1, further comprising a chassis member which comprises an opening corresponding to the display area, and which supports the display panel and the light source unit.

6. The display apparatus according to claim 5, wherein the light sensing unit is positioned between the dummy pixel and the chassis member.

7. The display apparatus according to claim 5, wherein the chassis member comprises a portion framing the display area and overlapping the non-display area.

8. The display apparatus according to claim 7, wherein the light sensing unit is positioned between the display panel and the portion of the chassis member framing the display area.

9. The display apparatus according to claim 7, wherein the dummy pixel is overlapped by the portion of the chassis member framing the display area.

10. The display apparatus according to claim 1, wherein the data pixel comprises
a gate line to which a gate signal is applied,
a data line to which a data signal is applied, and which crosses the gate line, and
a data thin film transistor connected with the gate line and the data line, and
the dummy pixel comprises a dummy thin film transistor connected with the gate line and the data line.

11. The display apparatus according to claim 1, wherein the light source control unit controls the light source driving unit so that the driving power supplied to the light source unit increases when the brightness of the sensed light is smaller than a predetermined first reference value.

12. The display apparatus according to claim 11, wherein the light source control unit controls the light source driving unit so that the driving power supplied to the light source unit decreases when the brightness of the sensed light is greater than the first reference value.

13. The display apparatus according to claim 1, wherein the light sensing unit senses a color information of the light emitted from the dummy pixel, and
the light source control unit detects the color information from the sensed light, and controls the light source driving unit based on detected color information so that the color coordinate of the light has a predetermined second reference value.

14. The display apparatus according to claim 13, wherein the dummy pixel receives a video signal corresponding to white.

15. A display apparatus, comprising:
a display panel which comprises a data pixel which is formed to a display area, and a dummy pixel which is formed to a non display area;
a light source unit which supplies a light to the data pixel and the dummy pixel; and,
a light sensing unit which senses the light emitted from the dummy pixel;
wherein a data thin film transistor of the data pixel and a dummy thin film transistor of the dummy pixel are connected to a same data line and a same gate line.

16. The display apparatus according to claim 15, further comprising a chassis member which comprises a portion framing the display area and overlapping the non-display area, and supports the display panel and the light source unit, wherein the light sensing unit is positioned between the display panel and the portion of the chassis member framing the display area.

17. A control method of a display apparatus which comprises a light source unit, the control method of the display apparatus comprising:
providing a display panel with a data pixel to a display area, and a dummy pixel to a non display area;
sensing a light which is emitted from the light source unit via the dummy pixel; and
controlling a driving power which is supplied to the light source unit so that at least one of brightness and a color coordinate of sensed light has a predetermined reference value.

18. The control method of the display apparatus according to claim 17, wherein controlling the driving power comprises increasing the driving power when the brightness of the sensed light is smaller than a predetermined first reference value.

19. The control method of the display apparatus according to claim 17, wherein controlling the driving power comprises detecting color information from the sensed light, and supplying the driving power to the light source unit based on detected color information so that the color coordinate of the light has a predetermined second reference value.

20. The control method of the display apparatus according to claim 17, wherein providing the display panel with a data pixel and a dummy pixel includes connecting a data thin film transistor of the data pixel and a dummy thin film transistor of the dummy pixel to a same gate line and a same data line.
